(19) United States
(12) Patent Application Publication
(10) Pub. No.: US 2018/0116883 A1
(43) Pub. Date: May 3, 2018

(54) HELPER PAD

(71) Applicant: BRILLIANT PRODUCT DESIGN CO., New Taipei City (TW)

(72) Inventor: Ying-Chun YEN, New Taipei City (TW)

(21) Appl. No.: 15/697,999

(22) Filed: Sep. 7, 2017

(30) Foreign Application Priority Data
Nov. 2, 2016 (TW) 105135578

(51) Int. Cl. A61G 7/00; A61G 7/057

(52) U.S. Cl. CPC A61G 7/001; A61G 7/05769

(57) ABSTRACT

A helper pad includes a base layer, a capsule structure and a fluid drive device. The base layer substantially has a sheet structure. The capsule structure is arranged on the base layer, defines the accommodation space, and has an opening to communicate the accommodation space with the outside. The capsule structure includes a fixed region and a driven region. Through a delivery line, the fluid drive device is connected to the opening of the capsule structure and controls the fluid to flow into or exhaust from the accommodation space defined by the capsule structure. When the accommodation space is filled with the fluid, the fixed region is inflated, and a thickness of one side of the driven region is larger than that of another one side of the driven region.

### CROSS-REFERENCE TO RELATED APPLICATION

This application claims priority from Taiwan Application No. 105135578, filed on Nov. 2, 2016, in the Taiwan Intellectual Property Office, the content of which is hereby incorporated by reference in their entirety for all purposes.

### BACKGROUND OF THE INVENTION

### 1. Field of the Invention

The present disclosure relates to field of a pad which helps the patient to turn over. In particularly, the present disclosure relates to a helper pad capable of being moved easily and making the patient turn over easily.

### 2. Description of the Related Art

For the patient who must lie down on the bed long, because lying down on the bed long, it causes bedsores and makes the patient suffering painful and intolerable. The helper needs to help patient turn over to avoid bedsores, and also need to change the turning position frequently to make portions of the body of the patient exercised. Thus, the patient should turn over several times in one day. Moreover, the bedcover should be cleaned and changed at the appropriate time, and meanwhile, the patient should be moved, which is a hard thing to be performed. Since the helper is usually a woman, the force of the woman is generally small, and it needs much of time and force to turn over the patient for the woman. Over the years, arms and a waist of the helper will be damaged.

With the evolution of the times, advances in electronic technology, an electric mattress capable of turning over the patient have gradually proposed, but this causes the patient needs a new mattress capable of turning over the patient to replace the existing mattress. How to achieve the function of auxiliary turning over the patient without replacing the existing mattress and equipment then becomes a problem to be solved.

### SUMMARY OF THE INVENTION

In view of the above-mentioned problems of the related art, to solve the problems of the related art, the object of the present disclosure is to provide a helper pad capable of being moved easily and making the patient turn over easily.

Based on the object described above, the present disclosure provides a helper pad, which comprises a base layer, a capsule structure and a fluid drive device. The base layer substantially has a sheet structure. The capsule structure is arranged on the base layer, defines an accommodation space, has an opening to communicate the accommodation space with outside, and includes a fixed region and a driven region. The fluid drive device is connected to the opening of the capsule structure through a delivery line, and controls fluid to flow into or exhaust from the accommodation space defined by the capsule structure. When the accommodation space is filled with the fluid, the fixed region is inflated, and a thickness of one side of the driven region is larger than that of another one side of the driven region, thus achieving the object of turning over the patient.

Preferably, the base layer has a rectangular structure with two short edges and two long edges, an area of the capsule structure is the same as that of the rectangular structure, and the driven region is divided into a first capsule and a second capsule along with a middle line formed by a middle point of the two short edges of the base layer.

Preferably, in a first state, the first capsule is filled with the fluid, such that the thickness of the side of the first capsule adjacent to the one long edge of the rectangular structure is larger than that of the adjacent middle line.

Preferably, in a second state, the second capsule is filled with the fluid, such that the thickness of the side of the second capsule adjacent to the other one long edge of the rectangular structure is larger than that of the adjacent middle line.

Preferably, in the first state, a vertical sectional shape of the first capsule across a line parallel to the short edge is substantially a triangle.

Preferably, the fluid drive device selectively makes the fluid flow into the first or second capsule.

Preferably, when the capsule structure is not filled with the fluid, the capsule structure is substantially flat.

Preferably, the fluid drive device has pipes, and the fluid drive device connects to the capsule structure through the pipes, so as to control a flux of the fluid of the capsule structure.

Preferably, the helper pad further comprises a timer, wherein the timer generates a control signal according to a predetermined timing condition, so as to control the fluid to flow into or exhaust from the accommodation space.

Preferably, two sides of the base layer are oppositely disposed with handles, and the handles at the opposite two sides of the base layer are configured to connect to each other and penetrate through the base layer.

Preferably, the helper pad further comprises a flexible layer disposed on the capsule structure.

Preferably, the flexible layer is a foam layer or an emulsion layer.

As mentioned above, the helper pad provided by the present disclosure may have the one or more of the following advantages:

(1) For the helper pad provided by the present disclosure, when the capsule structure is not filled with the fluid, the capsule structure is substantially flat, and thus the helper pad provided by the present disclosure can be put in the existing mattress without replacing the existing mattress.

(2) For the helper pad provided by the present disclosure, when the fluid flows into the first capsule, a vertical sectional shape of the first capsule across a line parallel to the short edge is substantially a triangle, and thus preventing the patient from turning over too much.

(3) For the helper pad provided by the present disclosure, two sides of the base layer are oppositely disposed with handles, and handles at the opposite two sides of the base layer are configured to connect to each other and penetrate through the base layer, such that it reduces the force for moving the patient and increases convenience for cleaning the bed.

### BRIEF DESCRIPTION OF THE DRAWINGS

FIG. 1 is schematic diagram showing a structure of a helper pad provided by an embodiment of the present disclosure.

FIG. 2 and FIG. 3 are schematic diagrams showing operations of a helper pad provided by the embodiment of the present disclosure.

FIG. 4 is schematic diagram showing the connection of the delivery line and the first capsule in the embodiment of the present disclosure.

FIG. 5 and FIG. 6 are schematic diagrams showing operations of a helper pad provided by another one embodiment of the present disclosure.

FIG. 7 is schematic diagram showing the connection of the delivery line and the first capsule in the other one embodiment of the present disclosure.

### DETAILED DESCRIPTION OF THE EXEMPLARY EMBODIMENTS

The advantages, features and technical methods to achieve the present disclosure are described in more detail with reference to the exemplary embodiments and the accompanying drawings for a better understanding of them, and the present disclosure may be implemented in different forms, and should not be construed to be limited embodiments herein, on the contrary, the embodiments provided herein make the disclosure more clear and comprehensive and the scope of the present disclosure is fully transmitted to those skilled in the art, and the present disclosure is will be only defined by the accompanying claims.

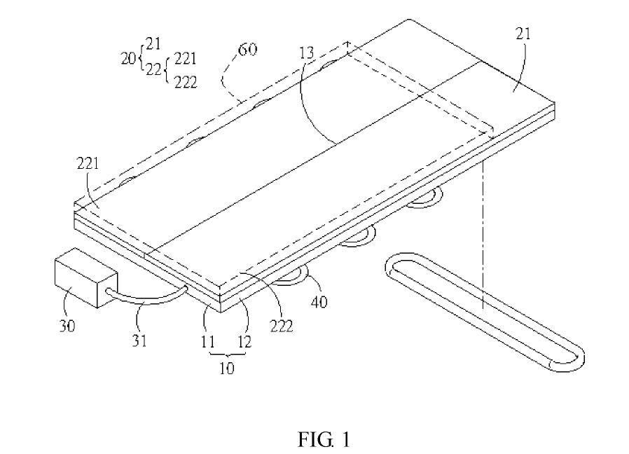

As shown in FIG. 1, which 1 is schematic diagram showing a structure of a helper pad provided by an embodiment of the present disclosure, the helper pad in the embodiment comprises a base layer 10, a capsule structure 20, a fluid drive device 30 and a flexible layer 60. The base layer 10 substantially has a sheet structure. The capsule structure 20 is arranged on the base layer 10, defines an accommodation space, has an opening to communicate the accommodation space with outside, and includes a fixed region 21 and a driven region 22. The flexible layer 60 is formed on the capsule structure 20, and can be the foam layer or the emulsion layer, but the present disclosure is not limited thereto. Since the helper pad is formed by the flexible layer 60, the capsule structure 20 and the base layer 10, it is obvious that the structure of the helper pad is a sandwich structure.

The fluid drive device 30 is connected to the opening of the capsule structure 20 through a delivery line 31, and controls fluid to flow into or exhaust from the accommodation space defined by the capsule structure 20. By controlling a flux of the fluid in the capsule structure 20 through the fluid drive device 30, the accommodation space is filled with the fluid, the fixed region 21 is inflated, and a thickness of one side of the driven region 22 is larger than that of another one side of the driven region 22, thus achieving the object of turning over the patient. When the capsule structure 20 is not filled with the fluid, the capsule structure 20 is substantially flat, and thus the helper pad provided by the present disclosure can be put in the existing mattress without replacing the existing mattress. By the way, the above fluid can be gas or liquid, such as air or water.

The base layer 10 has a rectangular structure with two short edges 11 and two long edges 12. A bottom surface of the capsule structure 20 is jointed with a top surface of the base layer 10, and thus an area of the capsule structure 20 is the same as that of the rectangular structure. The driven region 22 is divided into a first capsule 221 and a second capsule 222 along with a middle line 13 which is formed by a middle point of the two short edges 11 of the base layer 10. Thus, the fluid drive device 30 controls the fluid to flow into the first capsule 221 or the second capsule 222, so as to determine the direction which the patient turns over. The fixed region 21 is configured to reduce the times which the patient turns his/her head, such that it does not make the patient intolerable. In addition, the base layer 10 may be a conventional latex pad or a cleaning pad, and the base layer 10 may be an inflatable air cushion.

It is noted that, the two sides of the base layer 10 are disposed with handles 40. Slots are disposed on the connection parts of the handles 40 and the base layer 10. Each handle 40 is taken in the slot. The handles 40 at the two sides of the base layer 10 are configured to move the patient, and increase convenience to clean the bed for the helper, such that the patient can temporarily leave the helper pad to change his/her mood.

Specifically, the two sides of the base layer are oppositely disposed with handles 40, and the handles 40 at the opposite two sides of the base layer 10 are configured to connect to each other and penetrate through the base layer 10. The two handles 40 connected to each other are not come off or broken, such that it reduces the force of the helper for moving the patient, makes the helper clean the bed easily, helps the patient to temporarily leave the bed, increases convenience to care the patient for the helper, and makes the patient patients physically and mentally comfortable.

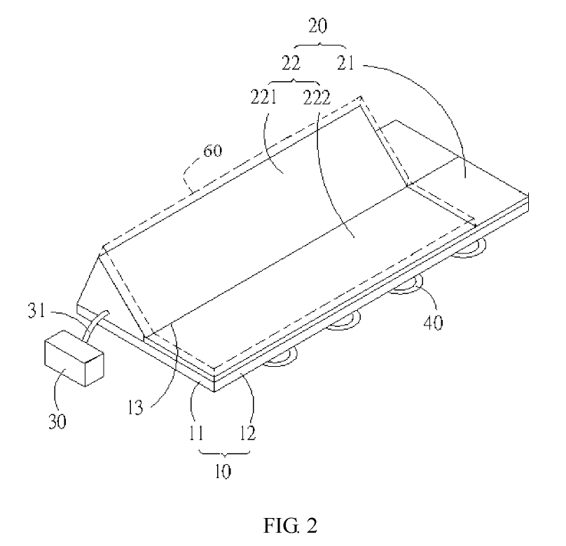

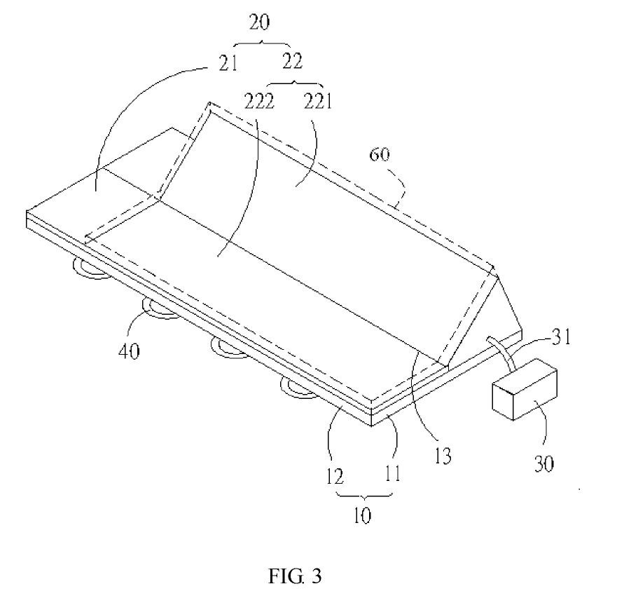

Referring to FIG. 2 and FIG. 3, FIG. 2 and FIG. 3 are schematic diagrams showing operations of a helper pad provided by the embodiment of the present disclosure. When the fluid drive device 30 selects to make the fluid flow into the first capsule 221, the first capsule 221 is filled with the fluid, such that the thickness of the side of the first capsule 221 adjacent to the one long edge 12 of the rectangular structure is larger than that of the adjacent middle line 13, and the first capsule 221 is inflated. When the fluid drive device 30 selects to make the fluid flow into the second capsule 222, the second capsule 222 is filled with the fluid, such that the thickness of the side of the second capsule 222 adjacent to the other one long edge 12 of the rectangular structure is larger than that of the adjacent middle line 13, and the second capsule 222 is inflated. When the first capsule 221 or the second capsule 222 is filled with the fluid, a vertical sectional shape of the first capsule 221 or the second capsule 222 across a line parallel to the short edge is substantially a triangle. Across the line of the inflated structure of the first capsule 221 or the second capsule 222 which is parallel to the short edge 11, the vertical sectional shape of the first capsule 221 or the second capsule 222 is triangle, thus preventing the patient from turning over too much to protect the safety of the patient. Additionally, the base layer 10 is used to support the driven region 22 while the driven region 22 is inflated, so as to maintain the triangle prism shape of the driven region 22, prevent the part of the driven region 22 close to the base layer 10 from being inflated too much, and efficiently control the inflation of the driven region 22.

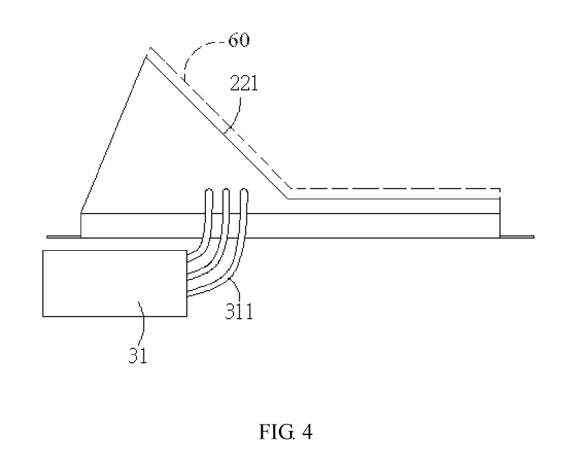

Referring to FIG. 4, FIG. 4 is schematic diagram showing the connection of the delivery line and the first capsule in the embodiment of the present disclosure. The fluid drive device 30 has pipes 311, and the fluid drive device 30 connects to the capsule structure 20 through the pipes, so as to control a flux of the fluid of the capsule structure 20. The fluid drive device 30 transports the fluid through the pipe 311. By controlling the flux of the fluid of the first capsule 221 adjacent to the middle line 13 is less than that of the fluid of the first capsule 221 adjacent to the long edge 12, the thickness of the side of the first capsule 221 adjacent to the one long edge 12 of the rectangular structure is larger than that of the adjacent middle line 13. Thus, across the line of the inflated structure of the first capsule 221 which is parallel to the short edge 11, the vertical sectional shape of the first capsule 221 is triangle. In the similar manner, the second capsule 222 is inflated according the mechanism.

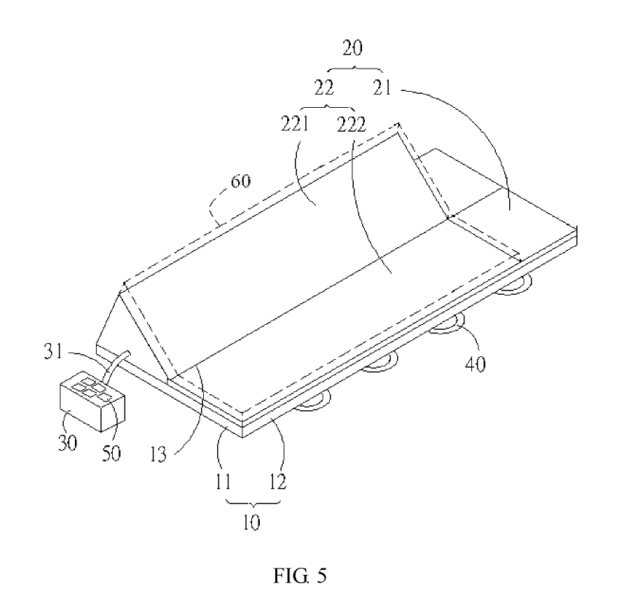

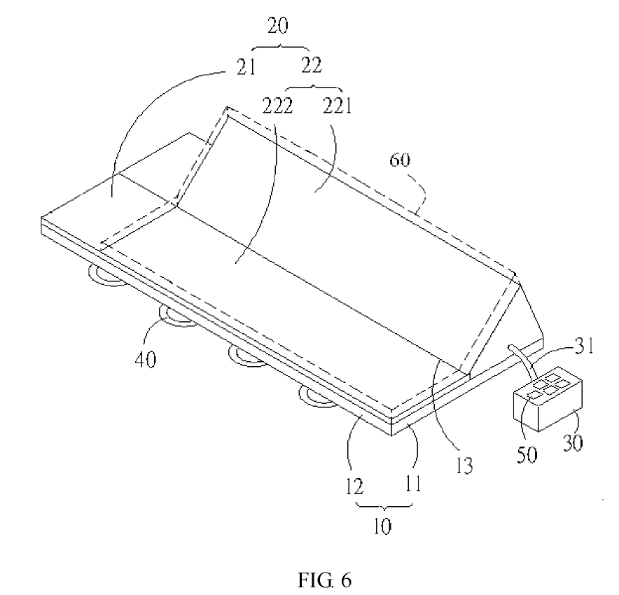

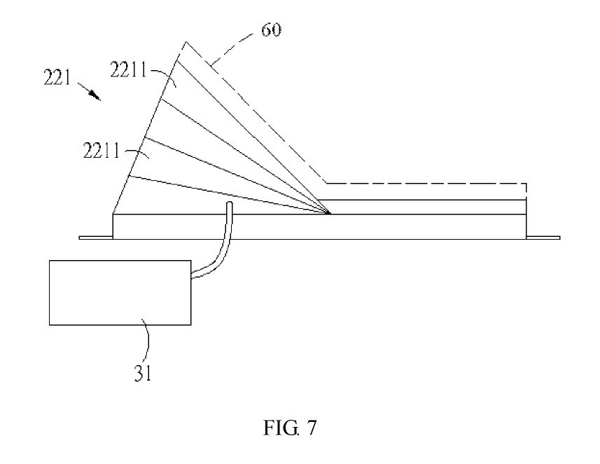

Referring to FIG. 5 through FIG. 7, FIG. 5 and FIG. 6 are schematic diagrams showing operations of a helper pad provided by another one embodiment of the present disclosure, and FIG. 7 is schematic diagram showing the connection of the delivery line and the first capsule in the other one embodiment of the present disclosure. In the other one embodiment, the components with the same label numbers are disposed and configured as those described above, and the redundant descriptions are omitted.

As shown in FIG. 5 and FIG. 6, the helper pad further comprises a timer 50. The timer 50 generates a control signal according to a predetermined timing condition. The control signal is transmitted to the fluid drive device 30, so as to control the fluid to flow into or exhaust from the accommodation space. The timer can be set to help the patient to turn over at the specific time, and thus the helper should not control the fluid drive device 30 to help the patient to turn over every time. Therefore, the burden of the helper is reduced, and the patient can exercise his/her body regularly to reduce the occurrence of bedsores on the patient.

As shown in FIG. 7, the first capsule 221 is formed with the sequentially stacked small capsules 2211, and the small capsules 2211 have triangle prism structures while inflated. One of the small capsules 2211 which mostly adjacent to the base layer 10 is the first small capsule 2211, one of the small capsules 2211 stacked on the first small capsule 2211 is the second small capsule 2211, and the other small capsule 2211 are named in this manner. When the fluid flows into the small capsules 2211, the fluid is firstly flow into the first small capsule 2211, the part adjacent to the first small capsule 2211 is gradually filled with the fluid and starts to be inflated. Due to the support of the base layer 10, the part of the first small capsule 2211 adjacent to the base layer 10 will not be inflated forward the base layer 10, and thus the inflated shape of the first small capsule 2211 is maintained. Next, the second small capsule 2211 starts to be inflated, and due to the support of the first small capsule 2211, the part of the second small capsule 2211 adjacent to the first small capsule 2211 will not be inflated forward the first small capsule 2211, and thus the inflated shape of the second small capsule 2211 is maintained. The other small capsules 2211 stacked on the second small capsule 2211 are inflated according to this inflation mechanism. The first capsule 221 is gradually filled with the fluid, and a side view observing from the short edge 11 of the rectangular structure shows the first capsule 221 has a triangle structure. When the first capsule 221 is completely inflated, an angle formed between the side of the first capsule 221 adjacent to the middle line and the short edge 11 of the rectangular structure can be 45 degrees. Therefore, it helps the patient to turn over more efficiently. In the similar manner, the second capsule 222 can be inflated according to the mechanism.

Accordingly, for the helper pad provided by the present disclosure, the flux of the fluid of the first capsule 221 and the second capsule 222 are controlled by the fluid drive device 30, so as to help the patient to turn over, and a side view observing from the short edge 11 of the rectangular structure shows the first capsule 221 or the second capsule 222 filled with the fluid has a triangle structure, so as to prevent the patient from turning over too much and protect the safety of the patient. Moreover, the two sides of the base layer 40 are disposed with the handles, such that it is convenient to move the patient for the helper. The helper pad further has the timer 50 to control the time that the patient turns over, so as to reduce the burden of the helper. The patient can move regularly to avoid occurrence of the bedsores. When the capsule structure 20 is not filled with the fluid, the capsule structure 20 is substantially flat, and thus the helper pad provided by the present disclosure can be put in the existing mattress without replacing the existing mattress. In short, the helper pad provided by the present disclosure has the above advantages to make the patient turn over regularly to reduce the occurrence of the bedsores and the burden of the helper.

The above-described embodiments are merely an exemplary illustration, and the present disclosure is not limited thereto. Any equivalent modification or change may be made thereto without departing from the scope and the spirit of the present disclosure and is covered by the appended claims.

What is claimed is:

1. A helper pad, comprising:
a base layer, substantially having a sheet structure;
a capsule structure, arranged on the base layer, defining an accommodation space, having an opening to communicate the accommodation space with outside, and including a fixed region and a driven region; and
a fluid drive device, connected to the opening of the capsule structure through a delivery line, controlling fluid to flow into or exhaust from the accommodation space defined by the capsule structure;
wherein when the accommodation space is filled with the fluid, the fixed region is inflated, and a thickness of one side of the driven region is larger than that of another one side of the driven region.

2. The helper pad according to claim 1, wherein the base layer has a rectangular structure with two short edges and two long edges, an area of the capsule structure is the same as that of the rectangular structure, and the driven region is divided into a first capsule and a second capsule along with a middle line formed by a middle point of the two short edges of the base layer.

3. The helper pad according to claim 2, wherein in a first state, the first capsule is filled with the fluid, such that the thickness of the side of the first capsule adjacent to the one long edge of the rectangular structure is larger than that of the adjacent middle line.

4. The helper pad according to claim 3, in a second state, the second capsule is filled with the fluid, such that the thickness of the side of the second capsule adjacent to the other one long edge of the rectangular structure is larger than that of the adjacent middle line.

5. The helper pad according to claim 3, wherein in the first state, a vertical sectional shape of the first capsule across a line parallel to the short edge is substantially a triangle.

6. The helper pad according to claim 2, wherein the fluid drive device selectively makes the fluid flow into the first or second capsule.

7. The helper pad according to claim 1, wherein when the capsule structure is not filled with the fluid, the capsule structure is substantially flat.

8. The helper pad according to claim 1, wherein the fluid drive device has pipes, and the fluid drive device connects to the capsule structure through the pipes, so as to control a flux of the fluid of the capsule structure.

9. The helper pad according to claim 1, further comprising a timer, wherein the timer generates a control signal according to a predetermined timing condition, so as to control the fluid to flow into or exhaust from the accommodation space.

10. The helper pad according to claim 1, wherein two sides of the base layer are oppositely disposed with handles, and the handles at the opposite two sides of the base layer are configured to connect to each other and penetrate through the base layer.

11. The helper pad according to claim 1, further comprising:
a flexible layer, disposed on the capsule structure.

12. The helper pad according to claim 11, wherein the flexible layer is a foam layer or an emulsion layer.
